(19) United States
(12) Patent Application Publication
(10) Pub. No.: US 2018/0181098 A1
(43) Pub. Date: Jun. 28, 2018

(54) OPERATION OF AN ELECTRICAL COMPONENT IN A CYBER-PHYSICAL SYSTEM

(71) Applicant: SIEMENS AKTIENGESLLSCHAFT, 80333 München (DE)

(72) Inventor: MATTHIAS DÜRR, Nürnberg (DE)

(73) Assignee: SIEMENS AKTIENGESLLSCHAFT, 80333 München (DE)

(21) Appl. No.: 15/324,551

(22) PCT Filed: Jul. 7, 2014
(86) PCT No.: PCT/EP2014/064460

§ 371 Date: Jan. 6, 2017

(51) Int. Cl. G05B 19/05

(52) U.S. Cl. CPC G05B 19/05; G05B 2219/31021

(57) ABSTRACT

The problem addressed by the invention is to operate an electrical component (16) in a cyber-physical system (22). The adapter device (36) provided according to the invention for coupling the component (16) to a data network (20) of the cyber-physical system (22) comprises: a communication unit (40) which is designed to receive defined request data (24) from the data network (20) independently of the component; an interpretation unit (50) which is designed to determine a command (68) executable using the technical features of the component (16) depending on the request data (24); an assessment unit (52) which is designed to generate a potential solution (70′) to the command (68) comprising at least one control signal (32) for the component (16) depending on operating data of the component (16); and a controller (66) which is designed to issue the at least one control signal (32) of the potential solution (70′) to a control interface (30) of the component (16).

The invention relates to a method for operating an electrical component, for example an electric motor or a sensor, from a data network of a cyber-physical system. The invention also relates to an automation installation which comprises the cyber-physical system and the electrical component, and to an adapter apparatus for coupling an electrical component to the data network of a cyber-physical system.

The use of a cyber-physical system is known under the term “industry 4.0” in connection with automation installations for carrying out a control and/or manufacturing process, for example a traffic light control installation in a city or a bottling installation in a brewery. The term “industry 4.0” describes a technological vision which represents technical solutions as cyber-physical systems (CPS). These systems are characterized, inter alia, by intensive networking and communication between the components which are involved and can be operated autonomously with their own control software.

A cyber-physical system denotes the group of IT software-controlled components with mechanical and electronic parts which communicate via a data infrastructure, that is to say a data network, for example the Internet or an intranet. Cyber-physical systems are formed by networking a central control unit which, without information relating to the specific technical equipment of the components to be controlled, emits a request relating to the operating behavior of the components. Only the components to be controlled convert the request into a specific operating behavior predefined by their technical equipment. For example, the central control unit may specify that an energy-saving quiescent state should be adopted for the next five minutes in an automation installation. This component-independent request is implemented by each of the components according to their technical equipment, that is to say according to their technical possibility. For example, ceiling lighting can be dimmed, whereas, in contrast, an electric motor can reduce its speed.

The transition from the current widely used conventional technology to this cyber-physical technology is a considerable problem. Current conventional components are generally centrally controlled, for example by programmable logic controllers, the control circuits of which have a deterministic behavior on account of qualified engineering instead of the autonomous self-configuration which is possible with components of a CPS. Current components are therefore optimized according to other criteria which differ considerably from the cyber-physical vision.

It cannot be assumed that existing systems can be quickly and completely replaced with a CPS since such conversion is cost-intensive and not all suppliers will adapt their product portfolios in the same manner. A long transitional phase with hybrid scenarios is foreseeable, in which conventional electrical components which require control by a programmable logic controller via a field bus must also be operated from a cyber-physical system.

Electric motors may constitute a special problem in this case. Electric motors for a particular task are conventionally designed, selected and installed according to relevant guidelines, for example the guideline VDE 0530 (IEC 34-17), in which rating data, operating modes, cooling methods and start-up behaviors can be stipulated. This results in a connection to the superordinate system; that is to say, the central control unit of a conventional automation installation takes into account the technical equipment of the components to be controlled when producing the central control commands. In order to produce a control command by means of a central control unit, it may therefore be necessary to first of all transmit the energy consumption, tacho signal, temperature signal, position signal and/or state of a protection release of the electrical component to be controlled from the electrical component to be controlled to a central control unit before the latter can decide which control command should be emitted next. The knowledge of the application consists, for example, of the selection of the motor, the design of the cables and the installation, the dimensioning of the power supply and the parameterization and programming of the controlling system.

In contrast, in the case of a CPS, it must be assumed that an existing conventionally designed motor is confronted with new requirements because, in a CPS, the central control unit produces component-independent request data which are also formed independently of the current operating state of the individual components. These requests must be able to be interpreted by the components to be controlled, on the one hand, and conflicts with the original design, for example a maximum speed or a maximum possible cooling performance, must be avoided, on the other hand. For example, the situation may arise in which the electric motor is intended to be operated in operating modes according to request data for which it was not originally designed, for example a frequent start/stop instead of continuous operation. The result may therefore be impermissible heating and/or increased wear of the electric motor. The previously clearly distributed responsibility for proper operation is lost in the hybrid scenario.

The invention is based on the object of operating an electrical component in a cyber-physical system.

The object is achieved by means of the subject matters of the independent patent claims. Advantageous developments of the invention emerge from the features of the dependent patent claims.

The problem is solved by means of an adaptation capsule in the form of a hardware and software apparatus which is used as a link between a conventional component dependent on central control, on the one hand, and a cyber-physical system, on the other hand. The fundamental structure of this adapter apparatus is as follows.

A communication device is designed to receive, from the data network of the cyber-physical system, request data which predefine an operating behavior of the device which is described independently of the technical equipment of the component, that is to say the request to save energy for the next five minutes, for example. An interpretation device is designed to determine, on the basis of the request data, a requirement which can be executed with the technical equipment of the component, that is to say, for example, to reduce an electrical power consumption of an electric motor of the component if the component has such an electric motor. As already stated, this is not always advantageous, however, if, for example, the wear of the electric motor is furthered thereby. A consideration device is therefore designed to generate, on the basis of operating data relating to the component, which indicate an operating state and/or an operating limit of the component, a possible solution for the requirement. Such a possible solution predefines at least one control signal for the component. For example, the possible solution in the example may comprise a control signal for reducing the speed of the electric motor, instead of completely stopping the latter. Finally, a controller is designed to output the at least one control signal of the possible solution to a control interface of the component. In other words, from the point of view of the component, the controller replaces a programmable logic controller (PLC) of a conventional plant controller, for example. The electrical component can nevertheless be controlled like a native component of the cyber-physical system via the data network by means of the adapter apparatus since the communication device of the adapter apparatus provides a communication interface like that in a native component of the cyber-physical system as well.

The adapter apparatus according to the invention results in the advantage that self-configuration of the electrical component for the component-specific implementation of the requested operating behavior is enabled on the basis of the component-independent request data emitted by a central control unit of the CPS via the data network. An electrical component which is not designed for operation in a cyber-physical system can therefore also nevertheless be operated from the cyber-physical system without a risk for wear or operational reliability.

Operating the adapter apparatus according to the invention results in the method according to the invention. The communication device receives, from the network, the request data from which a requirement which takes into account the technical equipment of the component is generated by the interpretation device. In connection with the invention, a requirement can be understood as meaning, in particular, a data record which assigns a specific component part to the request. For example, the request may relate to the energy consumption (“reduce energy consumption”), the throughput (“increase production rate or processing rate”) or the availability (“set maximum response time to the value x”). The interpretation device uses this to generate a requirement for a specific component part, for example an electric motor or a lighting system or a sensor. The interpretation device can therefore identify or assign an electric motor or a lamp or a measuring circuit, for example, with reference to the request. The consideration device now determines how the component part implements the requirement on the basis of operating data relating to the component by determining a possible solution for implementing the requirement. The consideration device can therefore take into account, for example, a switching frequency which is already available or a state of wear or a current temperature of the component and can then implement the requirement (for example power reduction or short requirement time), taking into account the operating data, by means of corresponding control signals which together form the possible solution. The controller then outputs the at least one control signal of the possible solution to a control interface of the component, for example an inverter of an electric motor or a control circuit for a lamp or a measuring circuit.

By virtue of one embodiment of the adapter apparatus according to the invention being integrated in an automation installation, the result is an embodiment of the automation installation according to the invention which can be used to carry out a control and/or manufacturing process in an installation area. Installation area means that area in which the components for controlling and/or monitoring the process are arranged, that is to say the actuators and sensors. The components are coupled, via a data network, to a central control unit which is designed to carry out the process according to an operating strategy defined in a cross-component manner. This operating strategy preferably comprises an optimization criterion for one of the following operating precepts: energy consumption, throughput, availability, wear or protection. Provision may also be made for the control unit to be designed to change over between at least two of the optimization criteria, that is to say to change the operating precept. The respective optimization criterion may predefine, in particular, minimization (energy consumption, wear) or maximization (throughput, availability), in which case a predetermined tolerance range comprising the extreme value may also be predefined.

In order to satisfy the optimization criterion with respect to the selected operating precept for the given operating strategy, provision is only made in a cyber-physical system for the central control unit to generate the corresponding component-independent request data on the basis of the operating strategy and to emit said data to the at least one component in the installation area via the data network. Unlike in the case of a conventional automation installation, the central control unit therefore does not take into account the respective technical equipment of the components.

It is nevertheless advantageously ensured in the automation installation according to the invention that an electrical component which is not designed for operation in a cyber-physical system nevertheless also converts these component-independent request data into an operating behavior corresponding to the operating precept, that is to say reduces its energy consumption or adapts its response behavior or its availability, for example.

One advantageous development of the adapter apparatus according to the invention provides for the interpretation device to be designed to check the request data from the data network for their relevance to the component and to generate a requirement only for those request data which have been identified as relevant. In this case, the interpretation device may be coupled to a memory which stores a mapping rule. The mapping rule makes it possible to predefine an assignment of component identifiers, which may be included in the requirement data, to the component parts of the component. If, for example, a requirement to reduce a power consumption of motors is received via the data network and the component is a fan, the interpretation device can identify that the request is relevant because the fan has an electric motor.

Another advantage arises if the consideration device determines a plurality of preliminary possible solutions for the requirement, rather than only a single possible solution. In this case, each possible solution is assigned a respective ranking value with respect to at least one of the following operating precepts: energy saving, throughput, availability, wear or protection. In this case, protection can be understood as meaning little wear of the component. Availability relates to the response time and/or dynamic response of the component. In order to now select a possible solution from the plurality of preliminary possible solutions, a decision-making unit arranged or connected downstream of the consideration device is provided and is designed to select, on the basis of a current operating precept, the best possible solution according to the ranking values for the current operating precept and to transmit said possible solution to the controller. If the component is already heavily worn, for example, protection may be provided as the operating precept. The gentlest possible solution is then accordingly selected. A component operated close to the maximum permissible operating temperature can predefine energy saving, for example, as the operating precept and can then implement the possible solution which is accordingly the most energy-saving solution.

The decision-making device advantageously results in self-protection of the electrical component.

A particular advantage emerges if the adapter apparatus can communicate in a bidirectional manner. For this purpose, according to one embodiment, a generation device is designed to emit report data, which describe a state of the components, into the data network via the communication device. The report data describe, for example, the possible solution implemented by the controller and/or the current control signal output to the component. In other words, an acknowledgement and/or a restriction, which is included in the possible solution, is/are output to the central control unit. The restriction may state, for example, that energy saving can be implemented only to a restricted extent for thermal reasons. The generation device results in the advantage that the central control unit can monitor the implementation of its operating strategy.

The request is adapted to the electrical component in a particularly flexible manner according to one embodiment in which a sensor interface is designed to receive at least one sensor signal which is dependent on the operating state of the component. This sensor signal is used by a monitoring device to determine a runtime state of the component. The monitoring device is designed to generate, on the basis of the at least one sensor signal, at least some of the operating data used by the consideration device, with the result that the possible solution is determined on the basis of these operating data.

With respect to the method according to the invention which has already been mentioned, the invention also includes developments of the method which have features that have already been described in connection with the developments of the adapter apparatus according to the invention. For this reason, the corresponding developments of the method according to the invention are not described here.

One exemplary embodiment of the invention is described below. In this respect:

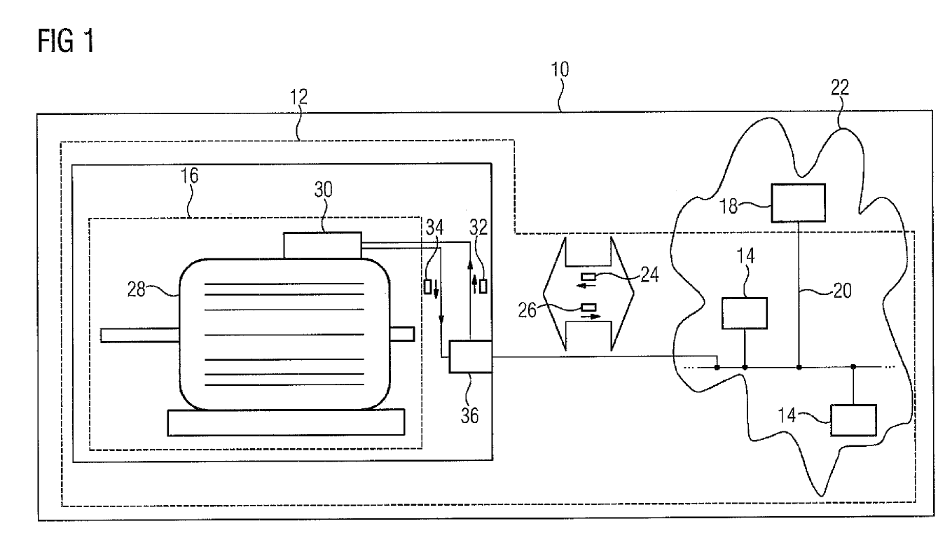

FIG. 1 shows a schematic illustration of one embodiment of the automation installation according to the invention,

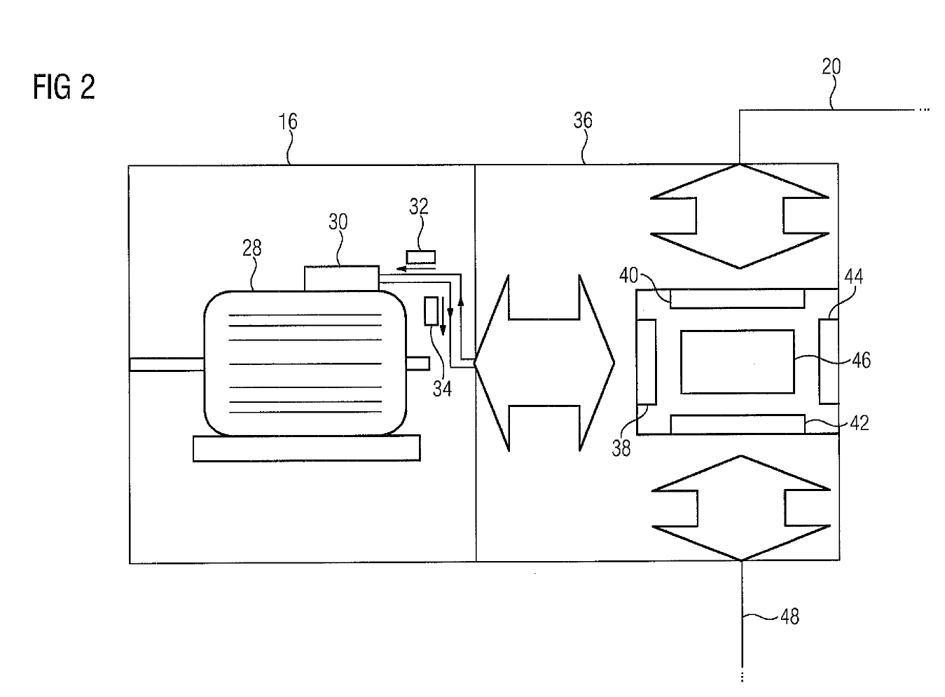

FIG. 2 shows a schematic illustration of one embodiment of an adapter apparatus which can be provided in the automation installation from FIG. 1,

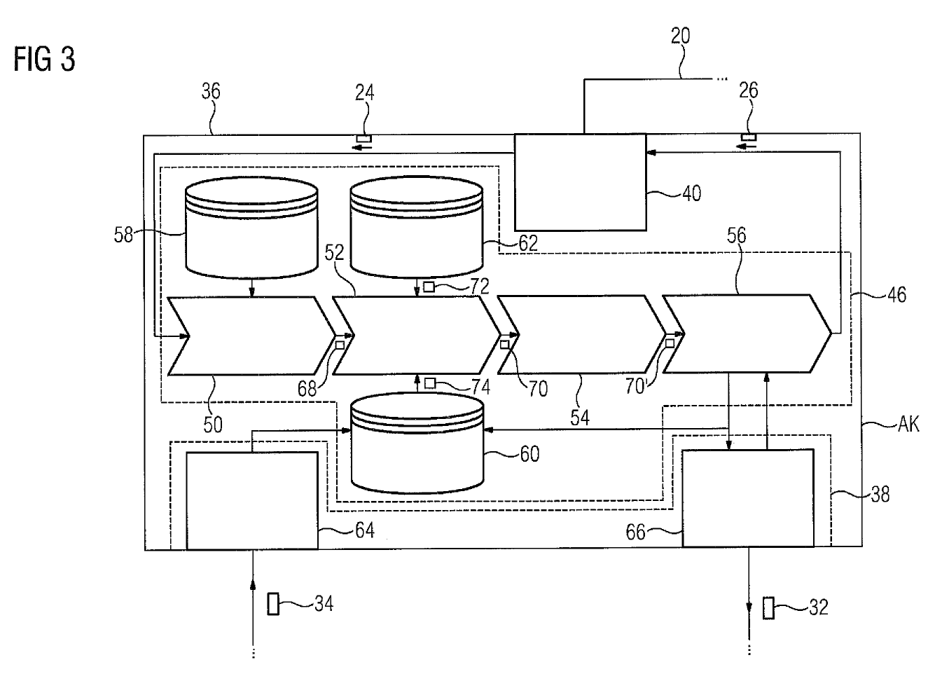

FIG. 3 shows a signal flow diagram for operation of the adapter apparatus from FIG. 2,

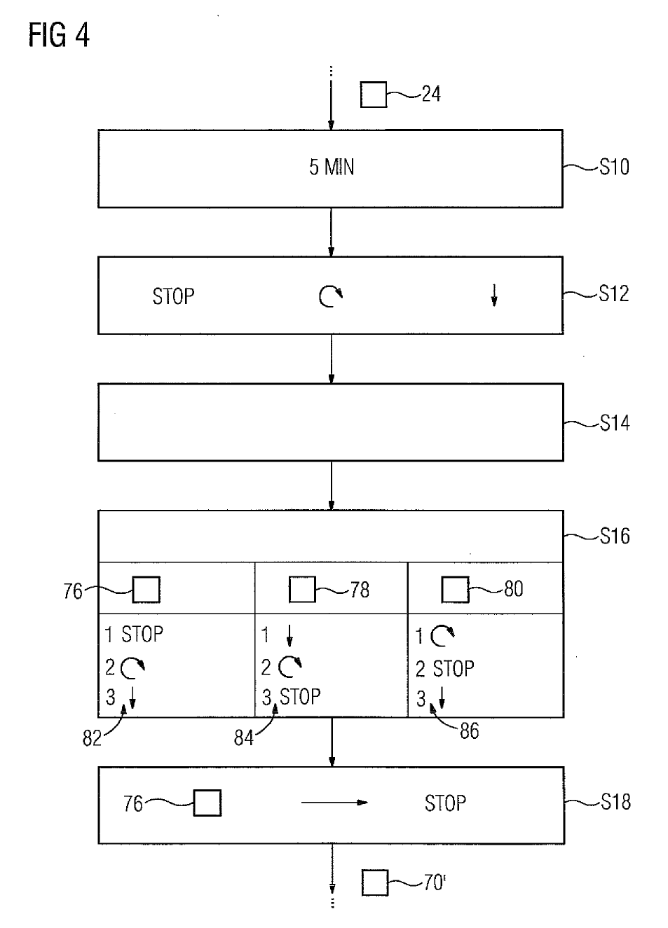

FIG. 4 shows a flowchart for one embodiment of the method according to the invention which can be executed by the adapter apparatus from FIG. 2.

The exemplary embodiment explained below is a preferred embodiment of the invention. In the exemplary embodiment, however, the described components of the embodiment are each individual features of the invention which can be considered independently of one another and each also develop the invention independently of one another and can therefore also be considered to be part of the invention individually or in a combination other than that shown. Furthermore, the described embodiment can also be supplemented with further features of the features of the invention which have already been described.

FIG. 1 shows an automation installation 10 which may be, for example, a manufacturing installation for injection-molded parts, for example, or a control installation for a process, for example for energy generation in a nuclear power plant or coal-fired power plant, or a control installation, for example for a traffic light system.

The automation installation 10 may have an installation area, or area 12 for short, in which components 14, 16 for controlling and/or monitoring the process of the installation 10 may be arranged. The installation area 12 may be, for example, a manufacturing hall or a site having a plurality of manufacturing halls or a district in the case of a traffic light control installation. The components 14, 16 may each be an actuator and/or a sensor. For example, the component may respectively be a controllable valve or a traffic light or an injection-molding machine or an assembly line or a conveyor belt or an electric motor.

In order to coordinate operation of the components 14, 16 and hereby carry out the process in the area 12, a central control unit 18 may be provided in the installation 10, which control unit may be a central computer, for example. The control unit 18 may be connected to the components 14, 16 via a data network 20 for the purpose of interchanging control data and state data. The data network 20 may also be entirely or partially wireless and may provide for data transmission, for example, via WLAN (Wireless Local Area Network) or else a mobile radio connection, for example UMTS or LTE. Wired transmission may be implemented by means of the Ethernet standard, for example. Data transmission can be coordinated by means of the Internet protocol (IP), for example.

In this case, data can be interchanged between the central control unit 18 and the components 14 on the basis of a communication protocol according to a CPS (cyber-physical system). The control unit 18 and the components 14 are therefore coupled, via the data network 20, to form a cyber-physical system or CPS 22 for short. For this purpose, the components 14 are designed with their own intelligence (not illustrated) or control unit which enables autonomous operation of the respective component 14 and in this case adjusts an operating behavior to requests from the control unit 18.

The component 16 can be configured to be extraneous to the system to the effect that it cannot interpret request data 24 from the central control unit 18. Furthermore, it may be possible for the component 16 not to be able to generate report data 26 according to the communication protocol of the CPS 22.

For the further explanation, it is assumed that the component 16 comprises an electric motor 28 and an inverter 30 for operating the electric motor 28. The inverter 30 constitutes a control interface of the component 30. In order to operate the component 16, it is therefore necessary to generate control signals 32 for controlling the inverter 30 and to map sensor data 34 from sensors arranged in the inverter 30 and/or the electric motor 28 to the request data 24 or the report data 26. For this purpose, the component 16 is coupled to the data network 20 via an adapter apparatus 36. The adapter apparatus may be configured as an adapter capsule AK, that is to say an adapter module with its own housing and electrical plug inputs and plug outputs.

For the further explanation, it is also assumed that the component 16 having the electric motor 28 is used in an industrial installation for a ventilation task. For this purpose, when building the installation 10, the motor 28, its protection, cabling and maintenance can be provided for the duration, for example in accordance with the operating mode S1, for example according to the international standard IEC 60034-1 or IEC 34-17.

A frequently cited benefit of converting to a cyber-physical system, such as the system 22, is the energy saving caused by the targeted disconnection of units which are not required, which is rarely feasible in the technology based on programmable logic controllers without explicit planning. In this case, the CPS 22 informs the subsystems of the automation installation 10, that is to say the components 14, 16, again and again over a plurality of hours, for example, that there is no need to ventilate the hall in question for several minutes. The electric motor 28 must then also react to this. For this purpose, the adapter apparatus 36 can interpret the request data 24, which may contain the energy-saving command, for the component 16 and can generate the associated control signals 32 if necessary.

For the method of operation of the adapter apparatus 36, reference is made below to FIG. 2, FIG. 3 and FIG. 4.

FIG. 2 shows the hardware or the circuit design of the adapter apparatus 36. The adapter apparatus 36 may have a physical interface to the component 16, that is to say the motor, which is referred to here as a component interface 38. The component interface 38 may correspond to that of an installation having central control using programmable logic controllers, for example, that is to say a bus connection for a Profinet bus, for example. The component interface 38 may comprise signal lines and also energy supply lines. A further physical interface is the communication interface 40 for interchanging data with the data network 20 of the CPS 22. In this case, it is possible to provide a communication interface 40 for an Ethernet, WLAN or LTE or else a combination thereof in the manner described. A supply interface 42 can be provided for supplying energy to the adapter apparatus 36 and/or the component 16, in which case a selection of a plurality of proposals for using the further possibilities of a CPS may be provided here, for example different busbars, each of which can have a different voltage level, or a connection option for an uninterruptible power supply UPS. For this purpose, the supply interface 42 may also contain or have switching apparatuses for transformation and/or energy buffering, for example. Finally, the adapter apparatus 36 may have an engineering interface 44 which can be used to configure and maintain an operating behavior of the adapter apparatus 36. The adapter apparatus 36 may be controlled by a microcontroller or a central processor or generally a processor device 46 which can be configured via the engineering interface 44. Furthermore, the processor device 46 may also have, for example, analog/digital converters and/or digital/analog converters in order to make it possible to convert between analog signals and digital data required for processing. The processor device 46 may also comprise a storage option for operating software of the adapter apparatus 36.

The adapter apparatus 36 therefore replaces the conventional field control which can be connected to the component 16 via a field bus and is implemented in the prior art using a programmable logic controller, for example. Information relating to energy, tacho signal, temperature signal, position signal and/or the protection release can be interchanged with the component 16 via the component interface 38. Energy from an energy supply network 48 can be distributed to the component 16 and (in the case of possible recuperative operation) back into the supply network 48 via the interfaces 38, 42.

The method of operation of the adapter apparatus 36 is described below using FIG. 3. The processor device 46 may provide the following modules, for example in the form of program modules: interpretation 50, consideration 52, decision-making 54 and order generation 56. Data memories or databases or generally knowledge bases can also be provided, for example an application knowledge base 58, a runtime state knowledge, base 60 and/or an engineering knowledge base 62. The component interface 38 may have a measurement data interface 64 and a controller 66.

The processor device 46 implements a runtime environment, that is to say a control loop or monitoring loop, in which the steps of interpretation, consideration, decision-making and order generation are executed by the respective module 50, 52, 54, 56 of the same name. The execution of external requirements is initiated by requests from the CPS 22, that is to say the request data 24.

The interface to the CPS 22 is formed by the communication interface 40 which can provide basic functions such as transmission/reception, data buffering, format conversion and security functions, for example VPN (Virtual Private Network), HTTPS (Secure Hypertext Transfer Protocol) and/or encryption.

The measurement data interface 64 evaluates information which is available beyond the immediate use of the sensor signals 34 from an electric motor 28, for example, and may be useful for the application, for example fingerprinting of a motor current, in order to draw conclusions on the state of windings and/or carbon brushes, for example, or ambient temperature monitoring in order to estimate the heat balance of the motor or generally the component 16, for example, or determination of tacho signal fluctuations in order to identify imbalances or bearing damage.

The controller 38 may replace the conventional control, which is carried out remotely in the prior art via a field bus, by storing and implementing possible solutions for the implementation which have arisen in response to a requirement from the CPS 22, that is to say one or more control signals, for example “switch on”, “set speed value to X”, “disconnect in the event of a temperature above 120 degrees Celsius” control signals. The controller 38 can also control the order generation 56 in order to continuously send quasi-analog state messages (“65.3 degrees Celsius”, “65.3 degrees Celsius”, “65.6 degrees Celsius” . . . ) or event-based “delta messages” (“temperature increase by 0.3 degrees Celsius to 65.6 degrees Celsius”) to the CPS 22 depending on the method of communication or communication mode predefined via the engineering interface 44 or by the central control unit 18.

The interpretation 50 receives incoming requests from the communication interface 40 and can evaluate the requests with regard to relevance to the control of the component 16. If it is, for example, a topic with regard to the component 16, for instance the electric motor 28 described in the example (here switching operations, energy consumption, typical applications may be relevant), the interpretation 50 can decide that the request data 24 are data relevant to the component 16.

The interpretation 50 can also determine a context; that is to say, it is possible to check, for example, whether the sender is relevant, whether the requirement matches the installation state and whether the requirement is inserted into a sequence of other notifications and/or dialogs with the CPS. For example, it is possible to check whether the request actually relates to that manufacturing hall in which the component 16 is installed. Only request data for this manufacturing hall are relevant.

If the relevance to the component 16 is identified by the interpretation 50, the requirement can be derived for the component 16, that is to say the electric motor 28, for example. The request data 24, which request energy saving for example, can be used to generate a specific requirement which states that the electric motor 28 is intended to be operated with less power for five minutes, for example.

In order to generate a requirement from the component-independent request, the application knowledge base 58 may be provided and may store, for example, which types of request data, which terms or designations or which senders are relevant to the component 16 and which requests from the sender, that is to say the control unit 18 for example, correspond to which technical equipment elements or their control parameters. As a result, the term “fan”, for example, may also relate to the motor 28 in the example by means of a corresponding mapping rule from the application knowledge base 58. The term “energy-saving controller” may likewise be a valid sender if this controller, as a central control unit 18, is in the same installation area 12 as the component 16. The request “save energy” can accordingly be translated into a requirement for disconnection or speed reduction.

The consideration 52 may compare the formulated requirement with the reality of the existing component 16, for example its design (continuous operation S1 in the example), an efficiency characteristic curve of the component 16, an assembly situation which may be the result of restricted thermal discharge for example, or a weakly dimensioned power supply/electrical protection. If it is possible to resolve the requirement 68, the consideration 52 can determine one or more possible solutions 70. For example, the request to save energy for five minutes for an electric motor 28 can be effected by means of disconnection, no-load operation or a reduced speed.

This constitutes three possible solutions between which a decision must be made. The possible solutions can be assessed taking into account the current runtime situation with respect to different operating precepts. The runtime situation may be, for example, a current motor temperature and ambient temperature above the intended normal temperature. The operating precepts may be, for example: energy saving and/or availability and/or performance and/or maintenance minimization (protection). For example, disconnection with respect to the operating precept of energy saving is given a higher assessment than reducing the speed. However, disconnection and restarting with respect to maintenance minimization is given a poorer assessment than merely reducing the speed. The consideration 52 therefore prioritizes each possible solution according to the different aims or operating precepts, with the result that a respective priority ranking of the possible solutions is produced with respect to each operating precept. The engineering knowledge base 62 and the runtime state knowledge base 60 can be used to determine the possible solutions and to assess or rank them with respect to the operating precept.

The engineering knowledge base 62 can describe the real component 16, that is to say the real motor 28 for example, if an installation situation and the energy supply, for example the catalog data, important deviations such as repairs or spare parts, special features of the cabling and/or protection and the assembly situation, are stored.

The runtime state knowledge base 60 may provide current operating data, their records, derived classification numbers and the maintenance state and/or a wear margin (for example a remaining number of operating hours or revolutions). The decision 54 on the selected alternative can be made on the basis of the possible solutions 70 from the consideration 52.

The engineering knowledge base 62 therefore provides operating data relating to operating limits 72 of the component 16. The runtime state knowledge base 60 can therefore provide operating data relating to the operating state 74 for the consideration 52. In this case, it is possible to find a solution which is optimal in this framework according to the operating data on the basis of the different aim-specific priority rankings each based on an operating precept. A decision can be made, for example, in favor of a solution which is the best alternative for availability and maintenance minimization, but may only be the second best solution for energy saving. In this case, the decision 54 can be made according to the stipulated operating precept, that is to say energy saving for example, or changing operating precepts stipulated by the CPS 22, for example. The selected possible solution is then output as the possible solution 70′ to be carried out.

The method for determining the possible solution 70′ from the request data 24 for the example described at the outset, in which the request data 24 may contain, for example, the requirement: “save energy for five minutes!”, as can be determined by the interpretation 50 in a step S10, is described again below using FIG. 4. In a step S12, the consideration can determine the following as possible solutions 70: disconnection, no-load operation, reduced speed. In a step S14, the possible solutions 70 can be assessed and runtime conditions from the runtime state knowledge base 60 can be used for this purpose, that is to say the operating data 74. For example, it is possible to determine that a severe accumulation of disconnection operations has already been observed in the past, for example the last hour or the last ten hours, with the result that the possible solution of “disconnect” is given a poorer assessment with respect to the operating precept of “maintenance” than no-load operation, for example. On the basis of the boundary conditions defined by the operating data 72, the reduction in the speed may result in there being poor efficiency, which can be accordingly assessed with respect to the operating precept of “energy saving”. With respect to no-load operation, it is possible to determine that, on account of the current temperature, sufficient cooling of the component 16 may be necessary, with the result that the aspect of wear (operating precept of protection) is accordingly assessed here.

A priority ranking according to different operating precepts 76, 78, 80 can be carried out therefrom in a step S16. For example, the operating precept 76 may relate to energy saving, the operating precept 78 may relate to availability and the operating precept 80 may relate to maintenance minimization. The possible solutions 70′—these are the stopping, the no-load operation and the reduced speed in FIG. 4—are accordingly organized in different rankings 82, 84, 86.

In a step S18, the decision 54 can now be used to determine which operating precept is currently intended to be followed. In the example, the operating precept of energy saving (76) is intended to be followed, with the result that the ranking 82 of the possible solutions is taken as a basis and it follows from this that the optimum solution is the disconnection of the component 16. This selected possible solution 70′ is transferred to the order generation 56.

On the basis of the selected possible solutions 70′, the order generation 56 is caused to generate the instruction for the controller 66 and possibly to initiate corresponding communication with the CPS 22, for example an acknowledgement by generating an acknowledgement message or a message relating to a restriction (“energy saving can be implemented only to a restricted extent for thermal reasons”). These are the report data 26 which are emitted into the CPS 22 by the adapter apparatus 36 via the data network 20. The order generation 56 can also provide the runtime state knowledge base 60 with current data, that is to say can store said data there, in order to assist with a comprehensive assessment of the operation for future decisions.

The controller 66 then generates the control signals 32 on the basis of the control instructions which are generated by the order generation 56 on the basis of the selected possible solution 70′.

The execution of internal requirements (for example quasi-analog, typical transmission of a temperature value) can likewise be initiated by the controller 66, in which case the transmission to the adapter apparatus 36 according to requirements from the CPS 22 can be initiated for this purpose, the corresponding request data 24 again being able to be interpreted by means of the application knowledge base 58 here.

The knowledge bases 58 and 62 may be provided with data before the runtime operation of the component 16 and of the adapter apparatus 36, and the application knowledge base 58 can be provided with data here according to the specification of the CPS 22, that is to say by the installation integrator or the person responsible for the entire system, for example. The engineering knowledge base 62 can be filled according to the situation of the respective component, that is to say by the relevant electrician, for example.

Overall, the adapter apparatus 36 in the example can therefore identify, using the application knowledge base 58, that the adapter apparatus 36 and the component 16 are meant by the request containing “ventilation” and “hall” described at the outset. Other subsystems, for example one or more of the components 14, may logically also be addressed in this case since the request is made in a component-independent manner. Furthermore, the adapter apparatus 36 can identify that disconnection is intended to be adopted as the state. A check is consequently carried out in order to determine whether other conditions argue against this, for example impermissible heating of the motor and lines. Since motors designed according to S1 are originally not designed and installed for frequent restarting, use in the operating mode S2 (short-term operation) may result in overheating. This can be retrieved from the runtime state knowledge base 60 or a condition from a maintenance note in the engineering knowledge base 62 may argue that the motor 28 definitely must not be disconnected on account of a defective start-up capacitor, for example. If the disconnection is enabled, the application knowledge base 58 can still be used to generate the query for adjacent subsystems as regards whether they have to restart at the same time; if so, the subsystems may agree on a restart which is not critical in the case of ventilation and is staggered by a few seconds in order to avoid generating peak loads in the energy supply. Central control by the control unit 18 is then also not necessary for this purpose.

Providing the adapter apparatus 36 enables a new approach for translating between the semantically complex world of the CPS 22 and the largely semantics-free communication possibility of an electric motor 28 or generally a component 16 which is dependent on control signals 32 from a control device.

The content-related configuration of the interface, that is to say the engineering of the adapter apparatus 36, may be effected by means of personnel local to the installation, with the result that the adapter apparatus 36 can be used in a very flexible manner and can be quickly integrated. Only a knowledge carrier for the configuration of the receiving CPS 22, that is to say a person responsible for the IT of the installation 10 for example, and a knowledge carrier for the component 16 in question, that is to say the motor 28 for example, and its installation, that is to say an installation electrician for example, are required. These two people can then carry out the engineering for the adapter apparatus 36 on an operating device, for example, and can store the selected configuration in the adapter apparatus 36 via the engineering interface 44. It is therefore particularly advantageous for subsequent implementation in installations (as can occur when modernizing an installation) and their retrofitting in order to benefit from synergies typical of industry 4.0, for example energy saving and/or resource protection.

The simple possibility of deciding according to changing operating precepts 76, 78, 80 while simultaneously taking into account the current operating conditions of the component 16 is also advantageous.

Overall, the example shows how the invention can provide an adaptation capsule for electric motors for incorporation in cyber-physical systems.

### LIST OF REFERENCE SYMBOLS

10 Automation installation
12 Installation area
14 CPS component
16 Conventional component
18 Central control unit
20 Data network
22 Cyber-physical system (CPS)
24 Request data
26 Report data
28 Electric motor
30 Inverter
32 Control signals
34 Sensor signals
36 Adapter apparatus
38 Component interface
40 Communication interface
42 Supply interface
44 Engineering interface
46 Processor device
48 Supply network
50 Interpretation
52 Consideration
54 Decision-making
56 Order generation
58 Application knowledge base
60 Runtime state knowledge base
62 Engineering knowledge base
64 Measurement data interface
66 Controller
68 Requirement
70 Possible solutions
70′ Selected possible solution
72 Operating limits
74 Operating state
76, 78, 80 Operating precept
82, 84, 86 Priority ranking
AK Adapter capsule
S10, S12, Method step
S14, S16, S18

1.-9. (canceled)

10. An adapter apparatus for coupling an electrical component to a data network of a cyber-physical system comprising:
a communication device which is configured to receive, from the data network, request data which predefine an operating behavior of the electrical component, the operating behavior described independently of technical equipment of the electrical component;
an interpretation device which is configured to determine, on the basis of the request data, a requirement which can be executed by the technical equipment of the electrical component;
a consideration device which is configured to generate a possible solution which predefines a control signal for the electrical component for the requirement on the basis of operating data relating to the electrical component, the operating data indicating an operating state and/or an operating limit of the electrical component; and
a controller which is configured to output the control signal of the possible solution to a control interface of the electrical component.

11. The adapter apparatus according to claim 10, wherein the interpretation device is configured to check the request data for their relevance to the electrical component and to generate the requirement only for the request data which have been identified as relevant.

12. The adapter apparatus according to claim 10, wherein the consideration device is configured to determine a plurality of preliminary possible solutions for the requirement and to assign each possible solution a respective ranking value with respect to the following operating precepts: energy saving, availability, throughput, and protection, and further comprising a decision-making device arranged downstream of the consideration device, wherein the decision-making device is configured to select, on the basis of a current operating precept, the best possible solution according to the ranking values for the current operating precept and to transmit the best possible solution to the controller.

13. The adapter apparatus according to claim 10, further comprising a generation device that is configured to emit report data into the data network via the communication device, wherein the report data describes the best possible solution implemented by the controller and/or the current control signal output to the electrical component.

14. The adapter apparatus according to claim 10, further comprising a sensor interface of the adapter apparatus, wherein the sensor interface is configured to receive a sensor signal which is dependent on the operating state of the electrical component, and, in order to determine a runtime state of the electrical component, the sensor interface is configured to generate, on the basis of the sensor signal, at least some of the operating data describing the operating state for the consideration device.

15. A system for carrying out a control and/or manufacturing process in an installation area comprising
an electrical component which is arranged in the installation area and is configured to control and/or monitor the process; and
a central control unit which is coupled to the electrical component via a data network and is configured to carry out the process according to an operating strategy defined in a cross-component manner and to emit component-independent request data to the electrical component via the data network on the basis of the operating strategy;
wherein
the electrical component is coupled to the data network via an adapter apparatus, and the central control unit is configured to emit the request data according to a communication standard for a cyber-physical system.

16. The system according to claim 15, wherein the operating strategy comprises satisfying a predetermined respective optimization criterion selected from the group consisting of operating precepts energy consumption, throughput, availability and protection.

17. The system according to claim 16, wherein the central control unit is configured to change over between any of the optimization criteria.

18. A method for operating an electrical component from a data network of a cyber-physical system comprising:
receiving request data by a communication device from the data network, wherein the request data predefines an operating behavior of the electrical component, wherein the operating behavior is described independently of technical equipment of the electrical component;
generating a requirement by an interpretation device on the basis of the request data, wherein the requirement is executable by the technical equipment of the electrical component;
determining by a consideration device a possible solution comprising a control for the electrical component for the requirement on the basis of operating data relating to the electrical component, wherein the operating data indicate an operating state and/or an operating limit of the electrical component; and
outputting the control signal of the possible solution by a controller to a control interface of the electrical component.
